(19) United States
(12) Patent Application Publication
(10) Pub. No.: US 2017/0214930 A1
(43) Pub. Date: Jul. 27, 2017

(54) GPU-ASSISTED LOSSLESS DATA COMPRESSION

(71) Applicant: Sandia Corporation, Albuquerque, NM (US)

(72) Inventor: Thomas A. Loughry, Albuquerque, NM (US)

(21) Appl. No.: 15/007,007

(22) Filed: Jan. 26, 2016

(51) Int. Cl. H04N 19/436; G06T 1/20; H04N 19/156; H04N 19/17; H04N 19/13; H04N 19/105; H04N 19/167

(52) U.S. Cl. CPC H04N 19/436; H04N 19/105; G06T 1/20; H04N 19/167; H04N 19/17; H04N 19/13; H04N 19/156

(57) ABSTRACT

Technologies for parallelized lossless compression of image data are described herein. In a general embodiment, a graphics processing unit (GPU) is configured to receive uncompressed images and compress the images in a parallelized fashion by concurrently executing a plurality of processing threads over pixels of the uncompressed images.

### STATEMENT OF GOVERNMENTAL INTEREST

This invention was developed under Contract DE-AC04-94AL85000 between Sandia Corporation and the U.S. Department of Energy. The U.S. Government has certain rights in this invention.

### BACKGROUND

Data compression is used to encode data with fewer elements, for example digital bits, than used in an original, uncompressed representation of the data. Lossless data compression takes advantage of statistical redundancies in the original data to compress data without losing any portions of the original data in the process. By contrast, lossy compression is subject to loss of portions of the original data during the compression process. Lossless compression thus allows the exact original data to be reconstructed from the compressed data. Data compression in general is used in a variety of different applications relating to the storage or transmission of various types of data. Lossless compression, in particular, is used in applications where the loss of even relatively small portions of the original underlying data may be unacceptable, for example medical and remote sensing imagery. In general, lossless compression algorithms are inherently serial processes. Thus, they are generally difficult to parallelize.

### SUMMARY

Technologies pertaining to parallelized compression of image data through use of a graphics processing unit (GPU) are disclosed herein. In a general embodiment, the GPU receives image data and holds the image data in one or more data buffers of the GPU prior to processing. Data is loaded into and unloaded from the buffers based upon a rate at which the image data is received at the GPU and a rate at which the GPU is able to compress the image data. The image data can comprise whole images or can comprise segments of larger images depending on a size of the images and a number of parallel processing threads of the GPU. Processing the image data in order to compress it comprises a two-step process wherein the image data is pre-processed through application of a predictor method to reduce entropy of the data. The GPU compresses the pre-processed image data according to a lossless compression algorithm; subsequently, the compressed data is transmitted by way of a transmission medium to a receiver.

Parallelism of the GPU architecture is exploited to enhance a compression rate and improve efficiency of the compression process when compared to the conventional serial approach. The GPU accumulates multiple images or multiple segments of images in the GPU buffers, wherein the multiple images or segments are images of a same scene or same portion of a scene taken at different times. When applying the predictor method, each of a plurality of GPU processing cores executes the predictor method algorithm over pixel data for a same pixel location across the multiple images or segments in parallel, resulting in pre-processed pixel data for each of the pixels in each of the images. In the second step of the process, executing the Rice compression algorithm is also parallelized. Each of the plurality of GPU processing cores executes, in parallel, the Rice compression algorithm over all of the pixels of one of the images or image segments, yielding a set of compressed images or image segments.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary system that facilitates compression of images using a GPU.

FIG. 2 is an exemplary illustration of allocation of image data across a plurality of data buffers of a GPU.

FIG. 3 is an exemplary illustration of a first kernel of a GPU executing over a plurality of pixel locations in a plurality of uncompressed image segments.

FIG. 4 is an exemplary illustration of a second kernel of a GPU executing over a plurality uncompressed image segments.

FIG. 5 is a flow diagram that illustrates an exemplary methodology for compressing images using a GPU.

FIG. 6 is a flow diagram illustrating an exemplary methodology for parallelized preprocessing and compression of images using a GPU.

FIG. 7 is a flow diagram illustrating an exemplary methodology for preprocessing and parallelized compression of images using a GPU.

FIG. 8 is an exemplary computing system.

### DETAILED DESCRIPTION

Various technologies pertaining to using a GPU to facilitate parallelized compression of image data are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Additionally, as used herein, the term “exemplary” is intended to mean serving as an illustration or example of something, and is not intended to indicate a preference.

Still further, as used herein, the terms “first plurality” and “second plurality” are to be understood to describe two sets of objects that can share one or more members, be mutually exclusive, or overlap completely. That is, if a first plurality of objects includes objects X and Y, the second plurality can include, for example, objects X and Z, A and B, or X and Y.

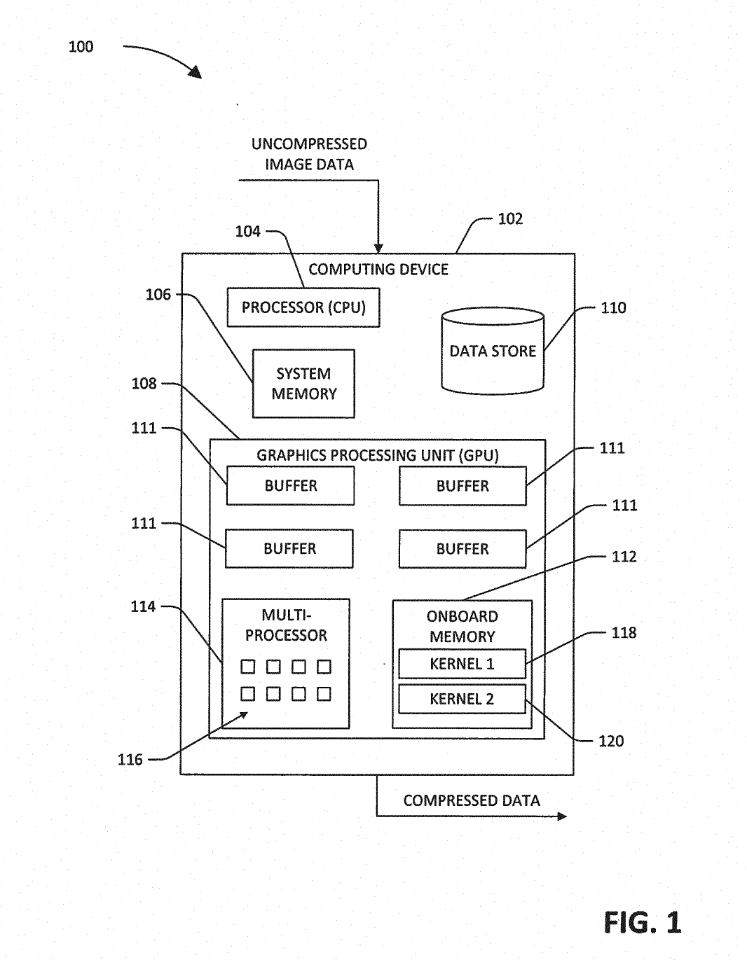

With reference to FIG. 1, an exemplary system 100 that facilitates parallelized compression of images with a graphics processing unit (GPU) is illustrated. The system 100 includes a computing device 102, the computing device 102 comprising a processor (CPU) 104, system memory 106 comprising instructions to be executed by the CPU 104, a GPU 108, and a data store 110. The GPU 108 and the CPU 104 can communicate with one another and access the system memory 106 and the data store 110. In operation of the system 100, the CPU 104 passes uncompressed image data to the GPU 108. The uncompressed image data comprises one or more images or image segments. The GPU 108 performs processing operations in parallel to compress the allocated data. The GPU 108 passes the compressed image data to the CPU 104, whereupon the CPU 104 causes the compressed data to be transmitted to a receiver that decompresses the compressed data. Additionally, the compressed data can be stored in system memory 106 and/or stored in the data store 110.

Additional details of the system 100 are now described. The GPU 108 comprises an onboard memory 112, which can be or include Flash memory, RAM, etc. In an exemplary embodiment, the GPU 108 can receive data retained in the system memory 106, and such data can be retained in the onboard memory 112 of the GPU 108. The GPU 108 further includes at least one multi-processor 114, wherein the multi-processor 114 comprises a plurality of stream processors (referred to herein as cores 116). Generally, GPUs comprise several multi-processors, with each multi-processor comprising a respective plurality of cores. A core executes a sequential thread, wherein cores of a particular multi-processor execute multiple instances of the same sequential thread in parallel.

The onboard memory 112 can further comprise a plurality of kernels 118-120. While FIG. 1 illustrates that the onboard memory 112 includes two kernels, it is to be understood that the onboard memory 112 can include any suitable number of kernels (e.g., hundreds or thousands of kernels). In general, the GPU 108 can be programmed using a sequence of kernels, where typically one kernel completes execution before the next kernel begins. In the system 100, the kernels 118-120 are programmed to compress image data by way of a lossless compression algorithm. Generally, each of the kernels 118-120 is respectively organized as a hierarchy of threads, wherein (as noted above) a core can execute a thread. The GPU 106 groups threads into “blocks”, and further groups blocks into “grids.” A multi-processor of the GPU 106 executes threads in a block (e.g., threads in a block are generally not distributed across multi-processors of the GPU 106). A multi-processor, however, may concurrently execute threads in different blocks. Thus, threads in a single block can be assigned to different multi-processors concurrently, to the same multi-processor concurrently (using multi-threading), or may be assigned to the same or different multi-processors at different times.

As noted above, the system 100 is configured to compress image data that, in an example, is received from an imaging sensor such as an aircraft-mounted imaging system. As used herein, compressing and encoding are collectively referred to as compressing, while decompressing and decoding may be collectively referred to as decompressing. An exemplary lossless compression algorithm is the Rice compression algorithm described in greater detail in the Consultative Committee for Space Data Systems (CCSDS), Lossless Data Compression, Green Book, CCSDS 120.0-G-2, the entirety of which is incorporated herein by reference. It is to be understood however, that other lossless compression algorithms are contemplated, such as those associated with acronyms JPG, TIFF, GIF, TARR, RAW, BMP, MPEG, MP3, OGG, AAC, ZIP, PNG, DEFLATE, LZMA, LZO, FLAC, MLP, RSA, etc.

Details of operation of the system 100 are now described. Uncompressed image data is received at the computing device 102. The uncompressed image data can be a series of images received from, for example, an aircraft-mounted imaging sensor or a medical imaging device. In an example, the uncompressed image data can be received by the computing device 102 as a continuous stream of image data, and the system 100 can receive and compress the image data on a continuous basis. In another example, the uncompressed image data can be received and compressed in discrete batches. The CPU can receive the data and can cause the data to be stored in system memory 106 or the data store 110. In another example, the GPU 108 can directly receive the data for processing.

For instance, the CPU 104 provides uncompressed image data to the GPU 108 for processing and compression. In an example, the uncompressed image data comprises an image frame or a plurality of image frames. Prior to passing the uncompressed frames to the GPU 108, the CPU 104 can segment the frames into image segments (e.g., when the frames are relatively large). The GPU 108 compresses image data more efficiently when more of the processing cores 116 are processing data. Segmenting the image frames into image segments can increase performance of the GPU 108 when compressing image data by engaging more of the processing cores 116 at once. An optimal size of the image segments for a given application can depend on various factors, including a final compressed size of the image segments, a size of the original uncompressed image frames, the number of GPU cores, etc. The image segments can also be of various shapes, for example square image tiles or contiguous scan lines. Furthermore, it is to be understood that the uncompressed images received at the computing device 102 may be of a size suitable for compression by the GPU 108 without requiring the CPU 104 to further break them down. In the description that follows, the terms “image segments” or “image frame segments” are intended to encompass images segmented by the CPU 104 or whole images as initially received by the computing device 102.

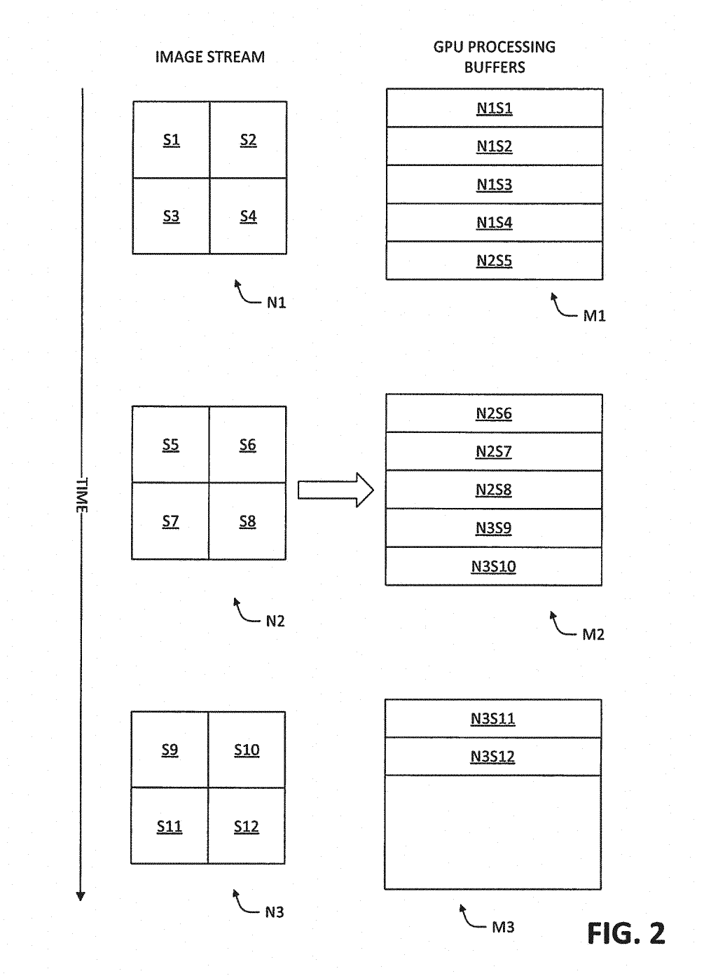

The GPU 108 includes several buffers (collectively referenced by reference numeral 111). While the GPU 108 is depicted in FIG. 1 as including four buffers, it is to be understood that the GPU 108 can include more or fewer buffers. In connection with compressing the image data, the GPU 108 receives the image frame segments at one of the buffers 111. Referring now to FIG. 2, an exemplary buffer allocation of image data received over a period of time is shown. The CPU 104 can, for example, receive images in a continuous stream, such as in a video. The stream of images can comprise a first image frame N1, a second image frame N2, and a third image frame N3. The CPU 104 can execute instructions that cause the CPU 104 to segment each of the image frames N1-N3. Specifically, image frame N1 can be segmented into segments S1-S4, image frame N2 can be segmented into segments S5-S8, and image frame N3 can be segmented into segments S9-S12. It can be ascertained that the segments shown in like positions may correspond to one another—i.e., segment S1 corresponds to segments S5 and S9. While the segments S1-S12 of the frames N1-N3 are depicted in FIG. 2 as being square subsections of the image frames N1-N3, it is to be understood that image segments can have substantially any geometry and can be, e.g., several contiguous scan lines. The GPU 108 allocates the segments to buffers M1-M3 based upon a chronological order of receipt of the images at the GPU 108. In an example, segments S1-S4 of frame N1 are received by the GPU 108 at a first time t, and are allocated by the GPU 108 to buffer M1, the allocated segments shown in FIG. 2 as N1S1-N1S4. Continuing the example, the GPU 108 receives frame N2 at a second time t+1, and allocates segments to the buffers M1 and M2 as N2S5-N2S8. As shown in FIG. 2, the segments N2S5-N2S8 can be allocated across two different buffers, M1 and M2.

The GPU 108 need not wait for a buffer to fill before passing its data to the multi-processor 114. In an example, the GPU 108 passes data from a buffer to the multiprocessor 114 upon identifying that one or more processing threads of the multiprocessor 114 is idle, regardless of whether the buffer is full. In another example, the GPU 108 passes first data from a first buffer to the multiprocessor 114 upon identifying that the multiprocessor 114 has finished executing operations over second data. By way of illustration, the GPU 108 receives frame N3 at a third time t+2, and allocates the segments N3S9-N3S12 across the buffers M2 and M3. If the GPU 108 processes the data in buffer M2 before a fourth image frame is received, the GPU 108 can begin processing segments N3S11 and N3S12 from buffer M3 without waiting for the buffer M3 to be filled. While the GPU 108 generally exhibits increasing performance with greater numbers of image segments per buffer, waiting for a buffer to be filled before beginning to process the data it contains can undesirably increase latency in the compressed image stream output by the GPU 108, since more time is required to accumulate the necessary input image segments.

Once the image data is received at the buffers 111, the GPU 108 executes a two-pass parallelized compression method by executing the first 118 and second 120 kernels of the GPU's onboard memory 112. More specifically, the GPU 108 includes an onboard system (not shown) that distributes data from the buffers 111 to appropriate multi-processors and underlying cores, wherein some of the cores are programmed to perform the predictor method and others are programmed to execute the lossless compression algorithm. Thus, in an example, the onboard system can determine that one of the cores 116 in the multi-processor 114 is idle and is awaiting data from the buffer, and the onboard system can allocate data from one of the buffers 111 to a register of the core.

In a first pass, the cores 116 of the multiprocessor 114 of the GPU 108 execute a predictor method over pixels of a plurality of image segments in parallel. In an example, the cores 116 of the multiprocessor 114 execute the predictor method by executing one or more processing threads over the pixels. The cores 116, when executing the predictor method, reduce entropy of the image data, which generally allows for greater compression ratios, a compression ratio being, for example, a ratio of an uncompressed size of an image to a compressed size of the image. The reduced entropy data created based upon the execution of the predictor method over the image segments is provided to other cores in the multi-processor 114 (or another multi-processor in the GPU 108), such that a second pass is taken over this output data. In the second pass, the aforementioned cores execute one or more processing threads over the reduced-entropy pixels of the image segments, thereby executing a lossless compression algorithm over the reduced-entropy image data. While the examples above indicate that different cores (possibly of different multi-processors) perform the different passes, it is to be understood that a core or cores can be reprogrammed, such that the core or cores can perform both the first pass and the second pass.

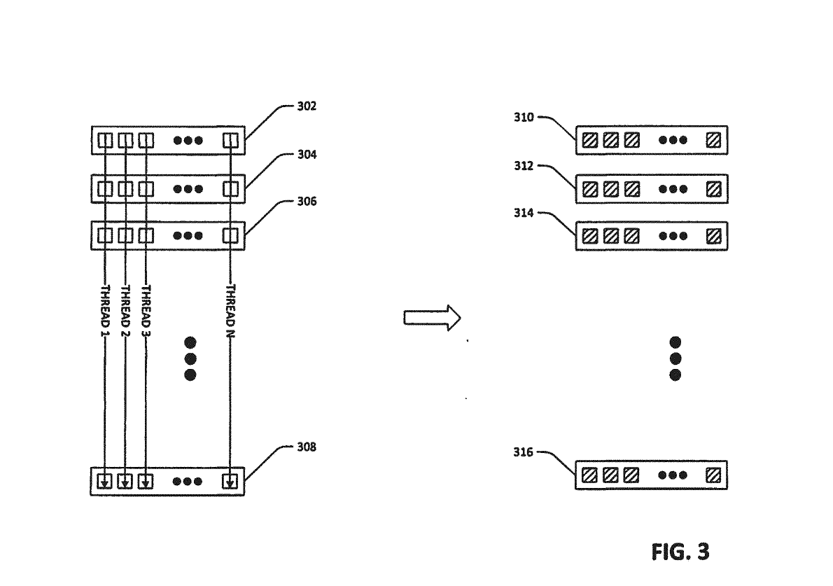

FIG. 3 illustrates execution of the first kernel 118 over uncompressed image data received by the multiprocessor 114 from the buffers 111 to generate reduced-entropy image data. The uncompressed image data comprises a plurality of M image segments 302-308, each comprising N pixels. The GPU 108 executes N processing threads over the M image segments 302-308. The M image segments 302-308 are processed in a chronological order of receipt, such that the first image segment 302 depicts a portion of an image received at time t, the second image segment 304 depicts the same portion of an image received at time t+1, etc. To further illustrate, in an example, the image data is imagery received from an aircraft-mounted radar observing a scene, and the M image segments each correspond to a lower left quadrant of respective M chronological images of the scene. For each image segment, each of the N processing threads is executed over N pixels, where each processing thread corresponds to one of N pixel locations in each of the M image segments. The first step of the image compression process corresponding to the first kernel 118 is application of a predictor method to reduce entropy of the image data. Pursuant to an example, the predictor method can be a “previous frame” predictor method, wherein a value of a pixel in a previous frame, for example an RGB value, is subtracted from a value of a pixel in the subject frame in a same corresponding location. More specifically, the value of a pixel at location (1, 1) in an image segment assigned time t−1 is subtracted from the value of a pixel at the same location in a corresponding image segment assigned time t. Pursuant to another example, the predictor method can be a “unit delay” method, wherein a value of first pixel to the left of a second pixel is subtracted from the value of the second pixel. Thus, the value of a pixel at location (1, 1) in an image segment is subtracted from the value of a pixel at location (1, 2) in the image segment. In each case, the execution of the predictor method by the N threads results in reduced-entropy image segments 310-316 corresponding to the respective image segments 302-308.

As a number of pixels in each image segment received by the GPU 108 increases, the number of processing threads that can be used to execute the predictor method over the image segment increases. In an example, the image segments 302-308 can be square segments of a size of 64 by 64 pixels, allowing as many as 4096 processing threads to be used to execute the predictor method over the image segments 302-308. The CPU 104 can select an image segment size based upon capabilities of the GPU 108, such as a number of parallel processing threads the GPU 108 is capable of executing, in order to facilitate efficient processing of image segments by the GPU 108.

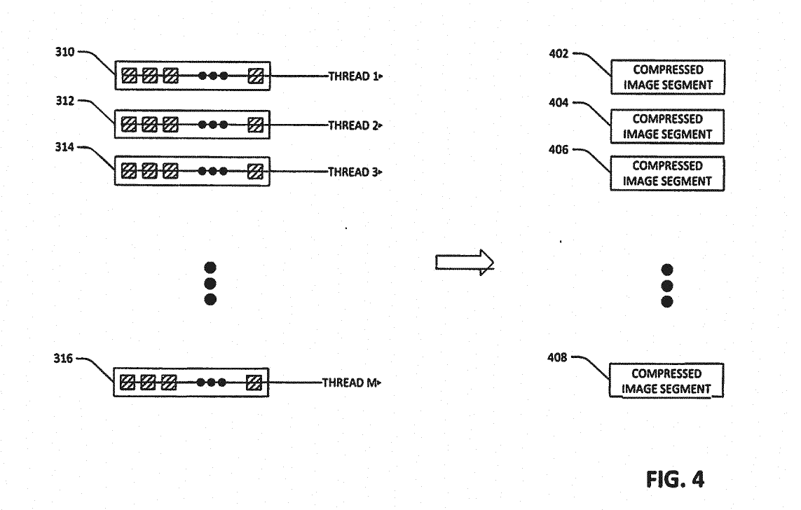

FIG. 4 illustrates execution of the second kernel 120 over the reduced-entropy image segments 310-316 to perform lossless compression of the reduced-entropy image segments 310-316. Here, cores of the GPU 108 execute M processing threads in parallel over the M reduced-entropy image segments 310-316 generated by execution of the first kernel 118, thereby compressing the segments 310-316 and generating compressed image segments 402-408. During execution of the second kernel 120, each of the M processing threads executes over all of the pixels of a respective image segment. Thus, the more image segments that are loaded into the buffers 111, the greater the parallelism that can be achieved in the two-step process. In one example, the buffer size is an adaptive buffer varying from 500 image segments to 1000 image segments.

Once the compressed image segments 402-408 have been generated by the GPU 108, the GPU 108 provides the segments 402-408 to the CPU 104. The CPU 104 can store the segments 402-408 in system memory 106 and/or the data store 110 for later transmission to a receiver. Prior to transmission to a receiver, the CPU 104 appends metadata to the compressed image segments 402-408. The metadata can be used by the receiver to reassemble complete images from the image segments 402-408 transmitted by the computing device 102. In an example, the metadata is data that is indicative of pixel locations in the uncompressed image data received by the computing device 102 and includes a correspondence between the compressed image segments 402-408 and the pixel locations.

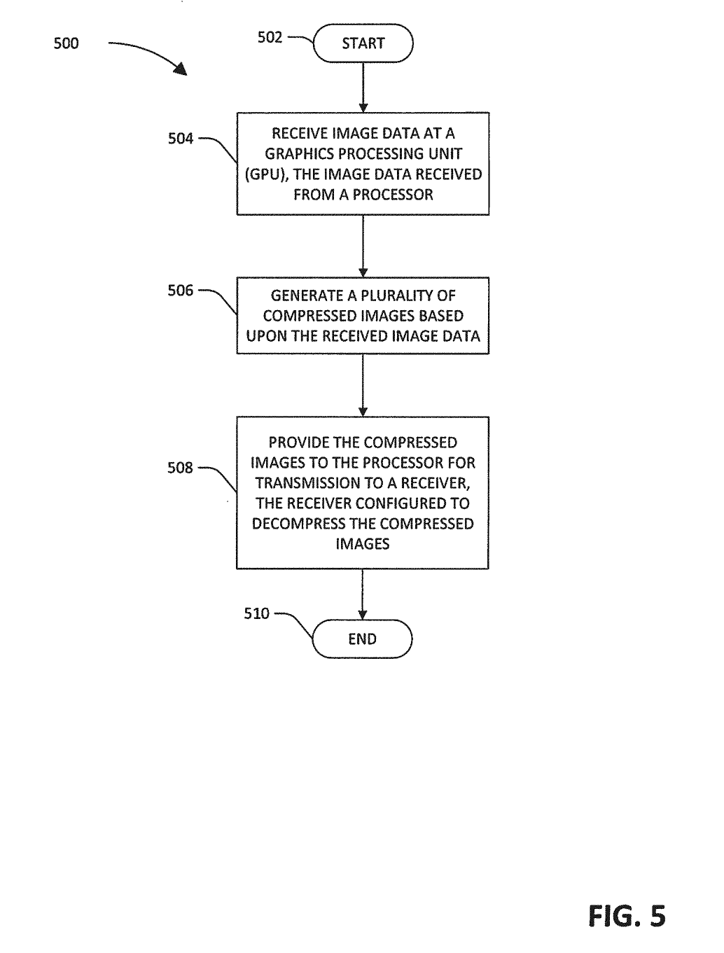

FIGS. 5-7 illustrate exemplary methodologies relating to parallelized compression of image data. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring now to FIG. 5, a methodology 500 that facilitates parallelized lossless compression of images is illustrated. The methodology 500 begins at 502, and at 504 image data is received from a processor at a GPU. In an example, the image data comprises a stream of uncompressed images captured by an imaging sensor over a period of time. In another example, the image data comprises a plurality of uncompressed segments of one or more images. At 506, a plurality of compressed images is generated based upon the image data received at 504. The GPU can generate the compressed images by execution of a lossless compression algorithm, for example a Rice compression algorithm, over the uncompressed image data. Moreover, generating the compressed images can comprise a multi-step process, the process comprising, for example, a preprocessing step and a compression step. At 508, the compressed images generated by the GPU are provided to the processor for transmission to a receiver, wherein the receiver is configured to decompress the compressed images. Pursuant to an example, the processor can transmit the compressed images in a continuous stream to a receiver as soon as the processor receives the compressed images from the GPU. Pursuant to another example, the processor can cause the compressed images to be stored for a period of time in system memory or a data store, and can transmit a batch of compressed images upon determining that a threshold number of compressed images has been accumulated in the memory or the data store. At 510 the methodology 500 ends.

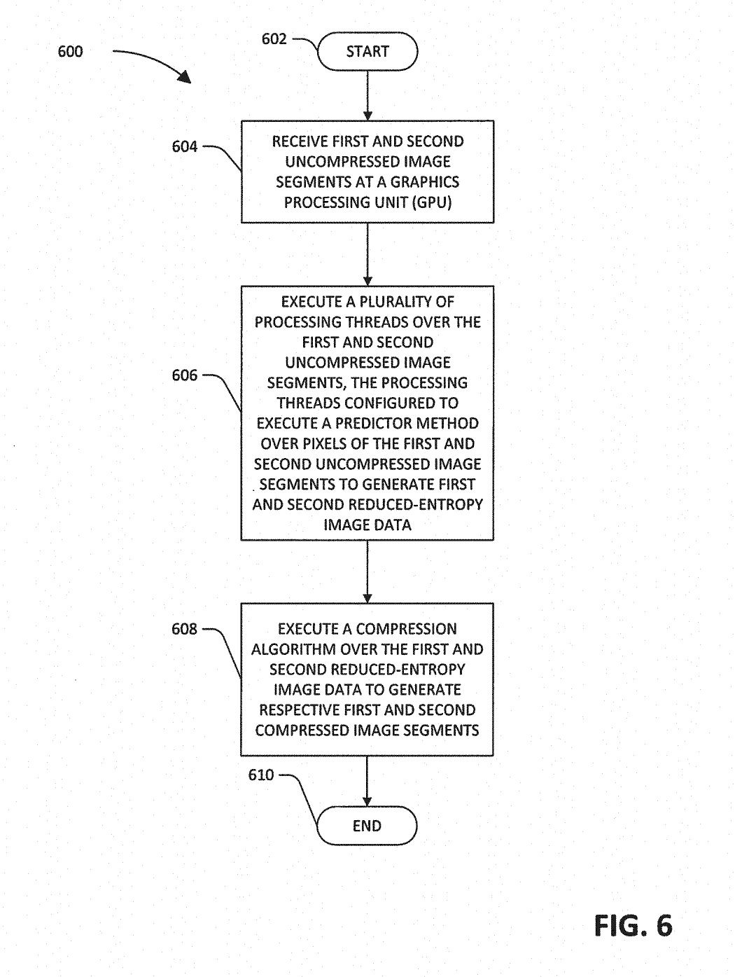

Referring now to FIG. 6, a methodology 600 that facilitates parallelization of an entropy-reducing preprocessing method is illustrated. At 602 the methodology 600 begins and at 604 first and second uncompressed image segments are received at a GPU. The first and second uncompressed image segments can be, for example, segments of first and second images of a scene captured by an image sensor at respective first and second times. The first and second uncompressed image segments can further correspond to a same location in the first and second images, e.g., a lower-left quadrant of the first and second images. At 606 the GPU executes a plurality of processing threads over the first and second uncompressed image segments, the processing threads configured to execute a predictor method over pixels of the image segments, thereby generating first and second reduced-entropy image data corresponding to the respective first and second uncompressed images. In an example, each of the plurality of processing threads is executed over a plurality of pixels, each plurality of pixels corresponding to a same pixel location in each of the first and second image segments. At 608, a compression algorithm is executed over the first and second reduced-entropy image data to generate respective first and second compressed image segments. Pursuant to an example, the compression algorithm can be a lossless compression algorithm, e.g., a Rice compression algorithm. The algorithm is executed by multiple processing threads in a parallelized fashion. Thus, for example, each processing thread can be executed over all of the pixels of the reduced-entropy image data corresponding to one of the uncompressed image segments received by the GPU. At 610 the methodology 600 ends.

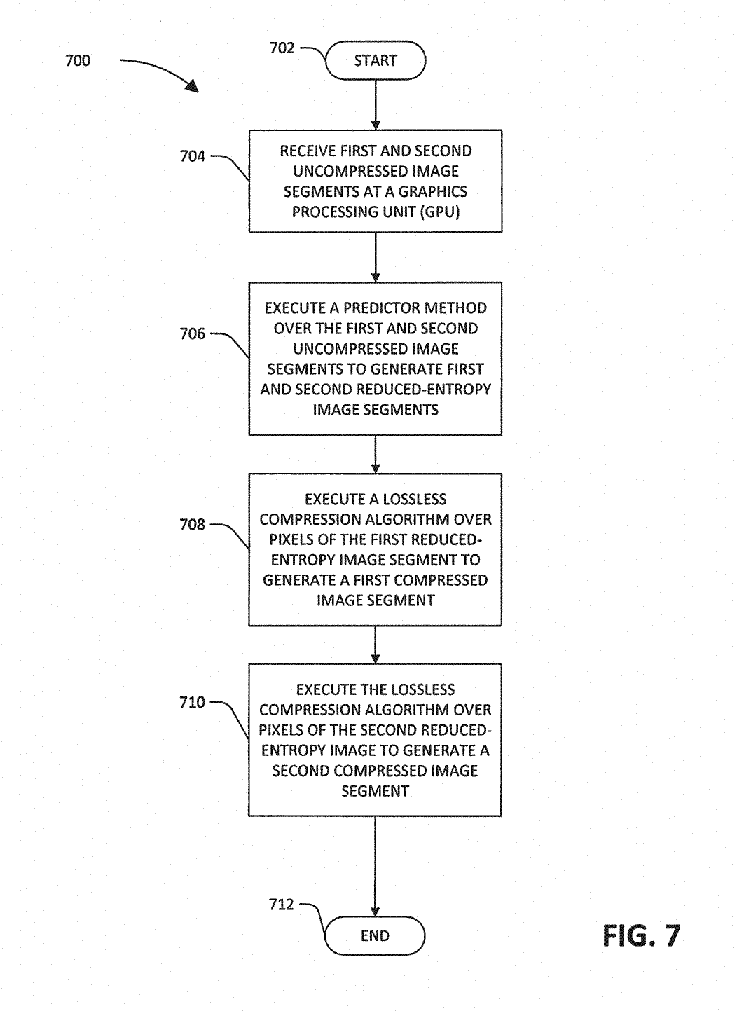

Referring now to FIG. 7, a methodology 700 that facilitates parallelization of a lossless compression algorithm executed at a GPU is illustrated. The methodology begins at 702 and at 704 first and second uncompressed image segments are received at a GPU. At 706 a predictor method is executed over the first and second uncompressed image segments to generate first and second reduced-entropy image segments. In an exemplary embodiment, the predictor method can be executed over the first and second uncompressed image segments according to the methodology 600 described above with respect to FIG. 6. At 708, a lossless compression algorithm is executed over pixels of the first reduced-entropy image segment, generating a first compressed image segment. At 710, the lossless compression algorithm is executed over pixels of the second reduced-entropy image to generate a second compressed image segment. In an embodiment, the lossless compression algorithm is executed in parallel by the GPU by concurrently executing one processing thread over each of the respective first and second reduced-entropy images. At 712 the methodology 700 ends.

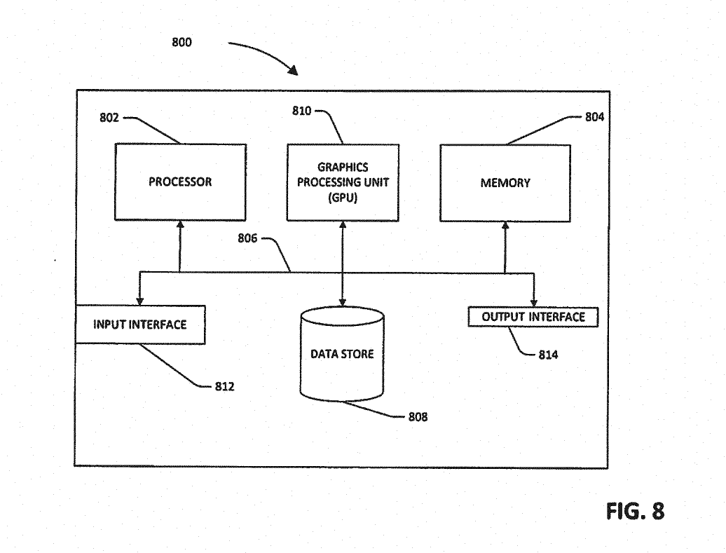

Referring now to FIG. 8, a high-level illustration of an exemplary computing device 800 that can be used in accordance with the systems and methodologies disclosed herein is illustrated. For instance, the computing device 800 may be used in a system that compresses image data. By way of another example, the computing device 800 can be used in a system that uses a GPU to facilitate parallelized compression of image data. The computing device 800 includes at least one processor 802 that executes instructions that are stored in a memory 804. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store uncompressed image data, compressed image segments, metadata, etc.

The computing device 800 additionally includes a data store 808 that is accessible by the processor 802 by way of the system bus 806. The data store 808 may include executable instructions, image data, etc. The computing device 800 additionally includes at least one GPU 810 that executes instructions stored in the memory 804 and/or instructions stored in an onboard memory of the GPU 810. The instructions may be, for instance, instructions for implementing functionality described as being carried out by one or more components discussed above or instructions for implementing one or more of the methods described above. For example, the GPU 810 may execute one or more kernels that can be used to compress uncompressed image data. The GPU 810 may access the memory 804 by way of the system bus 806.

The computing device 800 also includes an input interface 810 that allows external devices to communicate with the computing device 800. For instance, the input interface 810 may be used to receive instructions from an external computer device, from a user, etc. The computing device 800 also includes an output interface 812 that interfaces the computing device 800 with one or more external devices. For example, the computing device 800 may display text, images, etc. by way of the output interface 812.

It is contemplated that the external devices that communicate with the computing device 800 via the input interface 810 and the output interface 812 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 800 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 800 may be a distributed system. Thus, for instance, several devices may be in communication by way of a network connection and may collectively perform tasks described as being performed by the computing device 800.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method executed at a graphics processing unit (GPU), the method comprising:
generating a plurality of compressed image segments responsive to receipt of image data from a processor, the generating based upon the image data, wherein the GPU executes a lossless compression algorithm when generating the plurality of compressed image segments; and
providing the compressed image segments to the processor for transmission to a receiver, the receiver configured to decompress the compressed image segments.

2. The method of claim 1, wherein the lossless compression algorithm is a Rice compression algorithm.

3. The method of claim 1, wherein the image data comprises a plurality of uncompressed image segments, the uncompressed image segments being segments of an image captured by an imaging sensor, the image segmented by the processor.

4. The method of claim 3, wherein generating the plurality of compressed images comprises:
executing a predictor method over the uncompressed image segments to generate second image data; and
executing the lossless compression algorithm over the second image data to generate the compressed image segments.

5. The method of claim 4, the second image data comprising a plurality of reduced-entropy image segments.

6. The method of claim 4, the predictor method being a unit delay predictor method.

7. The method of claim 4, the predictor method being a previous frame predictor method.

8. The method of claim 1, the image data comprising first and second uncompressed image segments, the first and second uncompressed image segments being corresponding portions of first and second images of a scene, the first and second images captured at respective first and second times, wherein generating the plurality of compressed image segments comprises:
executing a first instance of a predictor method over a first pixel of the first uncompressed image segment and a second pixel of the second uncompressed image segment to generate first reduced-entropy data, the first and second pixels corresponding to a same pixel location in the first and second uncompressed image segments;
executing a second instance of the predictor method over a third pixel of the first uncompressed image segment and a fourth pixel of the second uncompressed image segment to generative second reduced-entropy data, the third and fourth pixels corresponding to a same pixel location in the first and second uncompressed image segments; and
executing the lossless compression algorithm over the first and second reduced-entropy data to generate first and second compressed image segments.

9. The method of claim 8, wherein the first and second instances of the predictor method are executed in parallel by respective first and second cores of the GPU.

10. The method of claim 8, wherein executing the lossless compression algorithm comprises:
executing instances of the lossless compression algorithm using different cores of the GPU.

11. The method of claim 10, wherein executing instances of the lossless compression algorithm comprises executing the instances of the lossless compression algorithm in parallel.

12. A system comprising:
a graphics processing unit (GPU), the GPU configured to perform acts comprising:
responsive to receiving uncompressed first image data from a processor, executing a lossless compression algorithm over the first image data to generate compressed second image data; and
providing the second image data to the processor for transmission to a receiver.

13. The system of claim 12, the GPU comprising a plurality of buffers, the first image data received from the processor at a first buffer in the plurality of buffers, the acts performed by the GPU further comprising:
receiving second image data at a second buffer in the plurality of buffers; and
responsive to determining that at least one of a plurality of processing cores of the GPU is idle, providing the second image data to the at least one processing core.

14. The system of claim 12, the system further comprising the processor, the processor configured to perform acts comprising:
segmenting a first uncompressed image into a plurality of uncompressed image segments, the first image data comprising the uncompressed image segments; and
providing the first image data to the GPU.

15. The system of claim 14, wherein the segmenting is based upon a number of processing threads of the GPU.

16. The system of claim 14, wherein the second image data comprises a plurality of compressed image segments, the acts performed by the processor further comprising:
appending metadata to the second image data, the metadata indicative of:
a plurality of locations corresponding to pixels in the first uncompressed image; and
a correspondence between the compressed image segments and the respective locations; and
transmitting the second image data and the metadata to the receiver.

17. The system of claim 12, wherein the lossless compression algorithm is a Rice compression algorithm.

18. The system of claim 12, wherein executing the lossless compression algorithm comprises:
executing a predictor method over the first image data to generate reduced-entropy image data; and
executing a Rice compression algorithm over the reduced-entropy image data.

19. The system of claim 18, wherein executing the predictor method over the first image data comprises executing a plurality of instances of the predictor method over the first image data, the instances of the predictor method executed in parallel by a first plurality of processing threads of the GPU, wherein further executing the Rice compression algorithm over the reduced-entropy image data comprises executing a plurality of instances of the Rice compression algorithm, the instances of the Rice compression algorithm executed in parallel by a second plurality of processing threads of the GPU.

20. A graphics processing unit (GPU) that is programmed to perform acts comprising:
receiving a plurality of uncompressed image segments, the image segments being segments of an image captured by an imaging device;
executing a predictor method over the image segments via a first plurality of cores of the GPU to generate a plurality of reduced-entropy image segments;
executing a lossless compression algorithm over the reduced-entropy image segments via a second plurality of cores of the GPU to generate a plurality of compressed image segments; and
providing the plurality of compressed image segments to a processor, the processor configured to transmit the compressed image segments to a receiver.
